(19) United States
(12) Patent Application Publication
(10) Pub. No.: US 2024/0351542 A1
(43) Pub. Date: Oct. 24, 2024

(54) THERMAL MANAGEMENT MODULE AND METHOD FOR MANUFACTURING A THERMAL MANAGEMENT MODULE

(71) Applicant: MAHLE INTERNATIONAL GMBH, Stuttgart (DE)

(72) Inventor: Holger ULRICH, Korntal-Munchingen (DE)

(21) Appl. No.: 18/639,070

(22) Filed: Apr. 18, 2024

(30) Foreign Application Priority Data
Apr. 21, 2023 (DE) 102023110222.2
Sep. 4, 2023 (DE) 102023123709.8

(51) Int. Cl. B60R 16/08; F28F 9/007

(52) U.S. Cl. CPC B60R 16/08; F28F 9/0075

(57) ABSTRACT

A thermal management module, in particular for an electrically powered motor vehicle is provided. The module consisting of at least one module carrier, with at least one connection flange, characterized in that the at least one module carrier is formed from a first and second cover plate, and that at least one channel plate is arranged between the first and second cover plate.

### CROSS-REFERENCE TO RELATED APPLICATIONS

This application claims priority from German Patent Application No. DE 102023110222.2, filed Apr. 21, 2023 and German Patent Application No. DE 102023123709.8, filed Sep. 4, 2023, the entirety of each are fully incorporated by reference herein.

The invention relates to a thermal management module, in particular for an electrically powered motor vehicle, and a method for manufacturing a thermal management module according to the preamble of the independent claims of the patent.

Previous thermal management modules use a component carrier, which as a central component receives the integrated components on the thermal management module. This can also have channels for conducting fluid.

DE 10 2021 203 031 A1 shows a thermal management module, which has a component carrier, on which components such as a heat exchanger, sensors, collector tanks and valve devices are arranged. The component carrier can also have channels for conducting fluid. The component carrier has a complex design and is for example made of a plastic or molded as a forged component or cast component. Any fluid-conducting channels can only be produced by means of expensive cores or by a multi-part structure of a complex molded single component.

Therefore, this invention deals with the problem of forming a thermal management module which includes a module carrier made of simply molded components and hence creates a module carrier that is robust, cost-effective and easy to manufacture, to which all the necessary components can be attached.

By way of comparison, the thermal management module according to the invention with the features of the independent claims has the advantage that, through the use of simple sheet metal components, which are manufactured by stamping, embossing and/or by a jet cutting process, a module carrier is formed, which on the one hand, has a simple design and can be cost-effectively manufactured, and on the other hand, creates a firm and stable basis, in order to be able to functionally accommodate components of the thermal management module.

So-called thermal management modules are understood to be devices which are designed to transport and distribute heat, in particular in an electrically powered motor vehicle. In particular, electrically powered motor vehicles are dependent on a particularly efficient heat management within the vehicle, since any heat loss simultaneously costs range of the vehicle. Therefore, thermal management modules having a simple design, which nevertheless fulfill all the necessary technical functions, are particularly in demand.

Typically, a plurality of components such as pumps, valve devices and heat exchangers are arranged in these thermal management modules. Moreover, typically a plurality of sensors, in particular pressure and temperature sensors, are integrated in such a thermal management module, said sensors generating sensor data. The heat exchanger can be for example a chiller or an indirect condenser for heat exchange between a refrigerant and a coolant. However, other heat exchanger types are also conceivable, which transfer the heat from a fluid flowing in the thermal management module to another fluid. Conceivable as a fluid is a coolant that for example can consist of water and an antifreeze agent like glycol. However, a low viscosity oil is also conceivable as a coolant. The thermal management module can also comprise one or more refrigerants, for example known refrigerants like R1234yf, R134a but also gaseous refrigerants like carbon dioxide (R744), propane (R290) or butane (R600).

The thermal management module according to the invention consists of at least one module carrier, which contains at least one connection flange. The components necessary for the operation of the thermal management module are installed on the module carrier. For example, this can be valve devices, which regulate the flow of fluids through the thermal management module, or sensors, which can be used to measure pressures and temperatures in the fluid circuits, or pumps, which can be used to deliver coolants, or collectors which can serve as reservoirs for coolants, or refrigerants heat exchangers, which can be used for heat exchange between fluids. Thus, a chiller as a heat exchanger can exchange heat between a refrigerant circuit and a cooling circuit or a so-called internal heat exchanger can be used for recovering heat from the backflow of a cooling circuit.

The components can be installed on connection flanges, which are arranged on the module carrier. Different requirements for the sealing or fastening are applicable for the connection to the connection flanges. Since the connections are not embodied directly on the module carrier, but rather are implemented via arrangeable connection flanges, the connection flanges can be appropriately matched to the components and can be used multiple times, even with different thermal management modules.

Thus, more than just one connection flange may be arranged on the module carrier. In particular, in particularly advantageous manner the necessary number of connection flanges may be provided, in order to accommodate all components. However, a connection of a component is also conceivable without using a connection flange, for example, when the necessary requirements for the connection can also be implemented directly from the module carrier itself. Thus, a heat exchanger could also be mounted directly on the module carrier. The installation itself could be achieved, for example, by means of self-tapping screws. The module carrier just needs to have the appropriate boreholes available for this. The sealing of the heat exchanger to the module carrier must be ensured via suitable sealing surfaces and sealants.

The module carrier has inner fluid guides, in order to be able to fluidically connect the components installed on the module carrier in appropriate manner and in order to be able to implement corresponding wiring of fluid circuits with the valve devices. The type of wiring and design of the fluid guides depends on the individual application of the thermal management module and is correspondingly defined for each type of a thermal management module to be manufactured.

However, it is also conceivable that the thermal management module is built from several module carriers, which are firmly connected to one another. For example, an especially variable design of the thermal management module could be achieved or other properties, such as the formation of a predetermined breaking point.

A module carrier is formed from a first and a second cover plate and at least one channel plate arranged between them. The cover plates close the module carrier upward and downward and hence limit it. In addition, the cover plates serve as a holding fixture for connection flanges and for the direct installation of components. The at least one connection flange is arranged on the first or second cover plate. It is also possible to arrange more than just one channel plate. The channel plates form inner fluid guides in the module carrier and hence facilitate the distribution of fluids within the thermal management module. The channel plates and cover plates can be firmly connected to one another. Preferably, several channel plates are arranged between the cover plates. The lateral surfaces of the cover plates and channel plates form the lateral surfaces of the module carrier, so that the module carrier is spatially limited by the cover plates and the lateral surfaces of the individual plates.

For the connection of the cover and channel plates to one another, the use of a soldering method like vacuum soldering, or the soldering method known by the brand name Nocolok, is conceivable. Especially preferably, solder-coated metal sheets can be used for this purpose, which, depending on the soldering method that is used, only need to be provided with a solder flux, in order to facilitate a defined soldering. However, it is also conceivable that cover and channel plates are connected to one another by means of bonding methods. To this end, a bonding layer is applied to the cover and/or channel plate and the bond is securely glued by supplying heat. The bonding layer can in the process be applied on a laminated film or also as a liquid adhesive.

At least the first cover plate and the channel plates are made of a sheet metal material. Preferably, this is an aluminum material, in particular, a material which has solderable properties. However, it is also conceivable that a cover plate or channel plate is made of a plastic.

In particularly advantageous manner, the cover plates and channel plates are made of a predominantly flat sheet metal. Predominantly flat means that the absolute majority of the surface is aligned in a plane and any locally present protrusions, which exert a special function on the flatness of the sheets, change nothing.

The cover plates are in particularly advantageous manner fully stacked on top of one another. This means that the flat metal sheets, in each case with complete coverage at least in the direction of one side of the sheet, following one above the other, form a single level of the module carrier. Hence, the stack with the single layers following one above the other forms the structural unit of the at least one module carrier. The outer edges of the sheets form the outer surface of the at least one module carrier. The advantageous design will not be disrupted if single sheets, for example, one of the cover plates, tower above the stack on the planar dimension. As a result of this, a fastening option can be generated through a kind of flange, for example by a circumferential or only partial projection of the cover plate. Corresponding mounting holes can be integrated in the sheet. In the process, the protruding sheet always covers at least one following stacked sheet in its entirety. A protruding sheet would also be conceivable in the middle of the stack, also several sheets on top of one another can have such a projection and thus form an especially stable flange.

The first and second cover plate have at least one opening. Preferably, the number of openings required for the supply and return flow of the fluids to be distributed in the thermal management module are integrated in the cover plates. Components and/or connection flanges are provided at these openings. Also, connection points for connecting hose lines, which distribute the fluids in the vehicle to other assemblies, to the thermal management module, can be provided. The openings can be round, or also have a form adapted to the connection flange, deviating from the circular cross-section.

The channel plates can have channels formed in the sheet metal. These can be manufactured for example by stamping, or also by means of a jet cutting method like laser or water jet cutting or by means of another mechanical processing. The channels are distributed over the channel plates as required and can take different forms.

Through the stack formation and the cover plates, the channels form fluid guides, said guides connecting the openings in the cover plates to coolants and refrigerant circuits, which are necessary for the function of the motor vehicle. Thus, different fluid circuits can also be directly or indirectly coupled in valve devices arranged in the thermal management module via heat exchangers, depending on the required operating mode. In the process, very complex channel guides are conceivable.

The channel plates can be similar in form. Thereby, with the number of channel plates the height of the fluid guide, and thus, the flow cross-section is determined. However, the channel plates can also have different channel geometries via the height of the stack. Thus, it is conceivable to create fluid guides spread over several levels or even intersecting fluid guides. Varying cross-sections can also be generated, which are realized in the event of the use of gaseous refrigerants that, for example expand in the case of condensation, and hence, over the course of the fluid guide require a larger cross-section.

It is also conceivable that the channels in the channel plates are formed and arranged to one another in such manner that a heat exchange is achieved between two fluids with the fluid guides formed thereby. For example, this heat exchange can then realize the function of an internal heat exchanger within the module carrier and hence replace an externally mounted separate heat exchanger. Two fluid guides could be designed directly adjacent lying within a plane, said fluid guides having only a thin partition to each other. Thus, a heat exchange can be implemented between these two fluid guides. If now a first fluid is conducted through the first fluid guide, this heat can be transferred to the second fluid in the second fluid guide. Depending on the application, the first and second fluid are taken from the same fluid circuit and hence constitute the same fluid, only in different temperature levels, as for example would be the case for an internal heat exchanger. However, a heat exchange between two different fluids would also be conceivable.

In a further advantageous embodiment, a channel can be formed in one or more channel plates, said channel not being used as a fluid guide. This channel can be filled with a vacuum or with air or with another gas. Hence, the channel is not connected to a component which can conduct fluid, in particular is not connected to an opening in a cover plate, which is equipped with a fluid port or connection flange. Thus, a formed channel can have a thermal insulating effect and hence, in advantageous manner thermally separate two fluid guides from each other in the channel plates. Thus, a first fluid with a higher temperature level can be thermally separated from a second fluid with a lower temperature level in advantageous manner. Hence, an undesirable heat transfer can be prevented. Instead of a side-by-side arrangement, the two fluid guides could also be arranged in different levels, thus on top of each other. It would also be conceivable that the fluid guides run arranged side by side and on top of each other and hence an advantageous heat exchange occurs. If the fluid guides could also be respectively arranged offset to each other in such a configuration, a particularly advantageous internal heat exchanger could be realized.

Turbulence generating structures could be inserted into the channels, in order to improve the heat transfer by generating turbulence. Separate appropriately formed inserts made of sheet metal could be used. It would also be conceivable to create a turbulence advantageous for the heat transfer through the corresponding design of the channels or by imprinting turbulence generating structures into the sheet metal closing the fluid guides, which can be the cover plates or differently formed channel plates.

The sheet metal used for the cover plates and channel plates can have a sheet thickness of 1 mm to 7 mm. In an especially preferable embodiment, the sheet thickness can be implemented in a range from 2 mm to 4 mm. Such a sheet thickness can still be machined well with conventional punching machines, without having to use special machinery, which can machine the thicker sheet metal. In particular, sheet metal that comes supplied on a roll from the manufacturer can also be used. This saves storage space and, to a particular degree, simplifies the processing and the transport. Moreover, a sufficiently high fluid guide can be realized in the module carrier for example, with a sheet thickness of 4 mm with just a few channel sheets.

Components can be directly arranged at the openings of the cover plates, such as heat exchangers or also connection flanges. These connection flanges are firmly connected to the cover plate and can have the functional surfaces necessary for the accommodation of the components, like sealing surfaces for O ring seals or also connection threads or screw-on threads for fastening the components. The connection flanges are machined, primary formed components or manufactured from one solid piece. Preferably, the connection flanges are made of a metallic or plastic material. If the connection flanges are soldered to the cover plate, a solderable metallic material must be used. A connection flange made of plastic and metal can also be bonded to the cover plate. However, one or more connection flanges can also be connected to the module carrier by other mechanical connection types, like screws. The type of connection to be used will be decided in the special design of the thermal management module.

In a further embodiment, it is also conceivable that the connection flanges are provided with the cover plates and the channel plates in a group for production of the module carrier, and are then soldered or bonded as an entire unit. In a further embodiment, it would even be conceivable to also arrange the not yet soldered heat exchanger in the group, and then connect the entire group to module carrier, connection flanges and heat exchanger in one soldering operation in a soldering furnace.

The second cover plate could also be made of plastic and bonded or screwed to the last channel plate. Thus, the simple structure of the module carrier and the simple formation of the channels in the module carrier can be combined with a more complex plastic component, which makes it possible to install numerous components. A plastic component could, for example also contain the collector for a coolant.

In a further embodiment according to the invention, the cover plates can have either an inward-facing or an outward-facing collar at the openings. With such a collar at an opening, for example in the case of an outward-facing collar, a centering option for the connection flange or also sealing surfaces for the sealing of connection flange and/or components to be installed can be created. The collar creates a longer contact surface, for example for an O ring seal, for which the mere plate thickness of the cover plate would not suffice. Also, as a rule, an opening formed by the stack of cover plate and channel plate cannot be used due to the increased requirements for the surface of the sealing surface for seals. Hence, with the collar a simple option can provided for creating such functional surfaces. An inward-facing collar can be used as a functional sealing surface. For example, in such a configuration it would be conceivable to seal a mounting pin to be provided with a seal of a heat exchanger to be installed directly on the channel plate via the collar. The collar could also be used for positioning the cover plate relative to the channel plate.

In a further embodiment according to the invention, the cover plates can have alignment elements. These alignment elements can be used for positioning and alignment of connection flanges or components to be installed on the cover plate. The alignment elements can be formed by embossing, toxing, slotting or by means of other forming processes. It would also be conceivable in a kind of riveting or welding process to attach pins as additional components to the cover plate, in order to form alignment elements. In particularly advantageous manner, for example with a collar at an opening and one or also two alignment elements, a connection flange or also a component may be absolutely defined on the cover plate and thus be arranged on the module carrier.

The method for manufacturing a thermal management module according to the invention with the features of the independent claim provides a first cover plate and arranges, stacked on the first cover plate, at least one first and second channel plate and seals the stack with a second cover plate. At least one first and second connection flange are likewise arranged on the first cover plate in the area of a first and second opening.

The raw module carrier formed with the stack is then either soldered or bonded in a furnace. In the case of soldering, if necessary, the sheets of the cover and channel plates are provided with a flux beforehand. The flux can be applied selectively to the areas at which the soldering should take place. In the case of a bonding, the metal sheets of the cover and channel plates are provided with an adhesive in the form of an adhesive foil or an adhesive application. By means of the introduction of heat, the bond joins to a ready to fit module carrier, to which the still missing components of the thermal management module can be mounted. For example, this can be a sensor and a valve device. In addition, a heat exchanger can also be mounted on the cover plate opposite the flanges. It is conceivable that heat exchangers are also arranged on the first cover plate and that connection flanges are also arranged on the second cover plate. The possible variations and application examples cannot be presented definitively here.

Further advantageous embodiments of the invention are described in the following descriptions of the figures. The figures show the following:

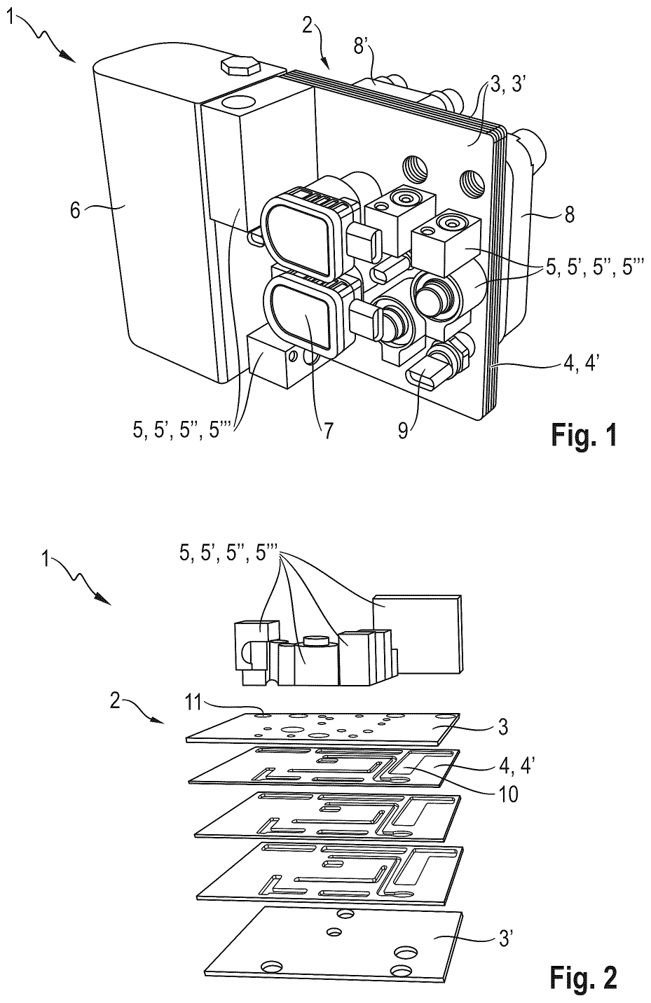

FIG. 1 shows a thermal management module according to the invention

FIG. 2 shows the module carrier of a thermal management module according to the invention in exploded view without mounted components

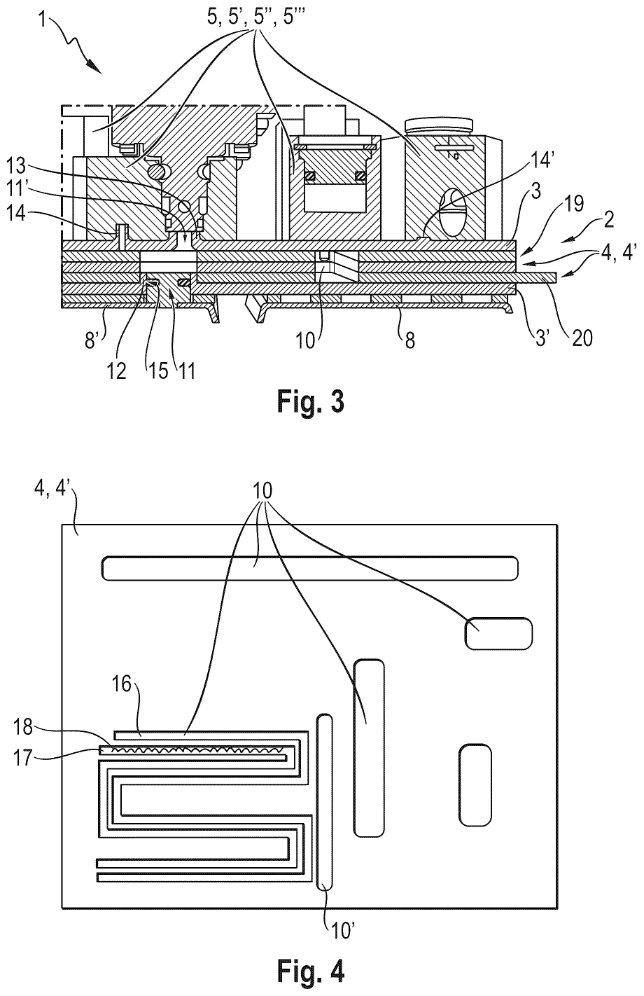

FIG. 3 shows a thermal management module according to the invention in a sectional view

FIG. 4 shows an exemplary channel plate with heat exchanging fluid guides

FIG. 1 shows an embodiment of a thermal management module according to the invention 1. The thermal management module consists of a module carrier 2, on which the different functional components of the thermal management module 1 are mounted. The module carrier 3 consists of a first cover plate 3 and several channel plates 4,4′, and is closed with a second cover plate 3′. In the process, the cover plates 3,3′ and channel plates 4,4′ are stacked and form a bond. The cover plates 3,3′ and channel plates 4,4′ are formed from flat metal sheets, which contain openings and channels. The openings, which are not visible in this figure, facilitate a connection of connection flanges 5,5′,5″,5″ arranged on the module carrier 2 and directly arranged components, like heat exchangers 8,8′.

Components like sensors 9, valve devices 7, collectors 6 are mounted on the connection flanges 5,5′,5″,5″. A connection flange 5,5′,5″,5″ can also serve as a connection point for a coolant or refrigerant line for transferring the fluids to the rest of the vehicle. The connection flanges 5,5′,5″,5″ are designed such that the components to be fastened thereon can be accommodated in precisely fitting and tight manner. As a result, the connection flanges 5,5′,5″,5″ can also be used in other embodiments of a thermal management module 1 and may be cost-effectively manufactured in large quantities. The connection flanges 5,5′,5″,5″ and also the cover plates 3,3′, and channel plates 4,4′ can be soldered or bonded to one another. It is also conceivable that single components or a single connection flange 5,5′,5″,5′″ is also mounted by means of another mechanical connection, in particular being screwed. To this end, the module carrier 2 can have preset openings or boreholes, into which then self-tapping screws can be screwed.

In the embodiment represented in FIG. 1, the heat exchangers 8, 8′ are arranged on the cover plate 3′ opposite the connection flanges 5,5′,5″,5″. However, any other arrangement of the connection flanges 5,5′,5″,5″ and heat exchangers 8,8′ on the cover plates 3,3′ is also conceivable. The plurality of possible combinations cannot be presented definitively here.

FIG. 2 shows the module carrier of a thermal management module according to the invention 1 in exploded view. The components mounted on the module carrier 2, such as heat exchangers 8,8′, valve devices 7, pumps, collectors 6 and sensors 9 are not shown. The module carrier consists of a first cover plate 3, which has several openings 11. These openings 11 serve as connection points for directly mounted components, or for connection flanges 5.5′,5″,5″. The connection flanges 5.5′,5″,5′″ are positioned on the first cover plate 3 and then soldered and/or bonded as a whole to the module carrier 2. The objective is to manufacture suitable connections, e.g., for valve devices 7, pumps, sensors 9, collectors 6 on the cover plate 3, which is made of a sheet metal. When the module carrier 2 is soldered or bonded, the components can be mounted on these connection flanges 5,5′,5″,5″ with the required tightness and firmness. For this reason, further functional surfaces, the necessary fastening thread and screw-on thread are provided in the connection flanges 5,5′,5″,5″. The connection flanges 5,5′,5″,5″ can be primary formed and machined or can be manufactured components machined from solid piece. The connection flanges can be extruded aluminum profiles, or also forged or sintered parts. The connection flanges 5,5′,5″,5″ are, in the process, preferably manufactured from a metallic, and in the case of soldering, also solderable metallic material. However, it is also conceivable that a connection flange 5,5′,5″,5′″ is manufactured from a plastic and is bonded to the cover plate 3.

The use of connection flanges for the components has the advantage that the connection flange can be used for a component in differently designed module carriers. Thus, components, which are used in similar manner in the different thermal management modules, for example valve devices or sensors, can be used universally. The differently formed cover plate simply receives the appropriate connection flange and the component can be mounted. Therefore, the connection flange can be manufactured particularly advantageously in large quantities.

Channel plates 4,4′ are arranged under the first cover plate 3. In the process, as many channel plates 4,4′ may be used as necessary for achieving the function. The channel plates 4,4′ are closed from the second cover plate 3′ on the opposite side of the first cover plate 3. Hence, a stack is formed which produces the module carrier 2. The cover plates 3,3′ and channel plates 4,4′ can be soldered and/or bonded. Through channels 10, which are formed in the channel plates 4,4′, fluid-tight fluid guides are thus formed, which, through further channels 10 or openings 11 in the channel plates 4,4′ and cover plates 3,3′ can correspondingly fluidically connect components arranged on the module carrier 2 to one another. In the simplest case, the channel plates are identical in shape, so that the number of stacked channel plates produces the height of the fluid guide in the channels 10. However, it is also conceivable that channel plates are formed in the staple with different channels 10, and hence complex fluid guides can be formed over several levels within the module carrier 2. The channel plates 4,4′ can be made of sheet metal, which is correspondingly punched or formed by a tool. Thus, in the event of large order volumes, a punching tool will be used, but in the event of lower order volumes it could also be a matter of a cut by a beam tool, such as a laser or water jet cutter. This enables a cost-effective manufacture of the corresponding channel plates in every situation. Due to the layered structure and the firm connection of the stack due to soldering or bonding, a module carrier 2 that can be flexibly designed is produced, which has a high strength and in addition, can be cost-effectively manufactured. The sheet metal used can have a sheet thickness of 1 mm to 7 mm. In an especially preferable embodiment, the sheets have a sheet thickness of 2 mm to 4 mm.

FIG. 3 shows a thermal management module according to the invention 1 in a sectional view. In so doing, a cut is made through the module carrier 2, revealing the exemplary structure of the module carrier 2, the positioning of the connection flanges 5,5′,5″,5″ and the installation of the heat exchangers 8,8′. The first cover plate 3 has at least one opening 11′. The opening has a collar 13 facing outward. This collar is used here for positioning of the connection flange 5′. In addition, the first cover plate 3 has alignment elements 14, 14′, which can likewise be used for positioning of a connection flange 5,5′,5″,5′″. In combination with a collar 13 or a further alignment element 14,14′, a connection flange 5′ can be precisely defined in its position. The alignment elements can be formed by means of embossing, stamping, toxing, slotting or by means of another forming operation.

The second cover plate 3′ can have an inward-facing collar 12 at the opening 11. This collar can be used for positioning of the cover plate 3′ to a channel plate 4,4′ and/or form a sealing surface 15. Since the cover plate 3′ is formed from a sheet metal and the wall in the sheet formed by the opening 11 does not suffice in its expanse as a contact surface for a seal, for example for the fluid-tight installation of a heat exchanger 8,8′, a sufficient sealing surface 15 can thus be created cost-effectively.

FIG. 4 shows an exemplary channel plate 4,4′ which is provided with several channels 10. Two of the channels form a first heat exchanging fluid guide 16 and a second heat exchanging fluid guide 17. The fluid guides 16, 17 are designed here such that they run parallel to each other and zigzag to each other. Thus, a good heat exchange is ensured. As thin a wall as possible between the two heat exchanging fluid guides 16, 17 ensures a good heat transfer. The design of the wall is such that a fluid-tight seal of the heat transferring first and second fluid guides 16,17 to each other is possible. Other designs are possible and cannot be presented definitively here.

In this configuration there are also turbulence generating structures 18 depicted, which can be inserted as separate components in the heat transferring fluid guides 16,17 or can also be formed in the channel plates 4,4′ or cover plates 3,3′.

The specification can be readily understood with reference to the following Numbered Paragraphs:
Numbered Paragraph 1. A thermal management module (1), in particular for an electrically powered motor vehicle, having at least one module carrier (2), with at least one connection flange (5,5′,5″,5″), characterized in that
the at least one module carrier (2) is formed from a first and a second cover plate (3,3′), which seal the at least one module carrier (2) upward and downward,
that at least one channel plate (4) is arranged between the first and second cover plate (3,3′), wherein the at least one channel plate (4) facilitates at least one inner fluid guide.

Numbered Paragraph 2. The thermal management module (1) according to Numbered Paragraph 1, characterized in that the at least one channel plate (4) has channels (10) and the first and the second cover plate (3;3′) each have at least one opening (11).

Numbered Paragraph 3. The thermal management module (1) according to Numbered Paragraph 2, characterized in that the at least one channel plate (4) and/or first cover plate (3) and/or second cover plate (3′) consist of a substantially flat sheet metal and is punched.

Numbered Paragraph 4. The thermal management module (1) according to Numbered Paragraph 2 or 3, characterized in that the at least one channel plate (4) and first cover plate (3) and second cover plate (3′) are fully stacked and the circumferential outer edges of the plates (4, 3, 3′) form outer surfaces (19) of the at least one module carrier (2).

Numbered Paragraph 5. The thermal management module (1) according to Numbered Paragraph 3 or 4, characterized in that the at least one channel plate (4) and/or first cover plate (3) and/or second cover plate (3′) has a sheet thickness of 1 mm to 7 mm, especially preferably from 2 mm to 4 mm.

Numbered Paragraph 6. The thermal management module (1) according to Numbered Paragraph 3, characterized in that the second cover plate (3′) is a plastic component.

Numbered Paragraph 7. The thermal management module (1) according to Numbered Paragraph 2, 3, 4, 5 or 6, characterized in that at least one second channel plate (4′) is arranged between the first cover plate (3) and the second cover plate (3′).

Numbered Paragraph 8. The thermal management module (1) according to Numbered Paragraph 7, characterized in that the first cover plate (3), the first channel plate (4) and the at least second channel plate (4′) and the second cover plate (3′) are fluid-tightly connected to one another, in particular being soldered or bonded.

Numbered Paragraph 9. The thermal management module (1) according to Numbered Paragraph 7 or 8, characterized in that the first channel plate (4) and the at least second channel plate (4′) have identically formed channels (10) or differently formed channels (10).

Numbered Paragraph 10. The thermal management module (1) according to Numbered Paragraph 9, characterized in that the channels (10) formed in the first channel plate (4) and the at least second channel plate (4′) form at least one first and one second heat exchanging fluid guide (16, 17), facilitating a heat exchange with each other.

Numbered Paragraph 11. The thermal management module (1) according to Numbered Paragraph 10, characterized in that a channel (10′) is formed in the at least first channel plate (4), which does not form a fluid guide and hence has a thermal insulating effect.

Numbered Paragraph 12. The thermal management module (1) according to Numbered Paragraph 10 or 11, characterized in that turbulence generating structures (18) are arranged in at least one of the first and second fluid guides (16, 17) exchanging heat with each other.

Numbered Paragraph 13. The thermal management module (1) according to any of Numbered Paragraphs 1 to 12, characterized in that the at least one connection flange (5,5′,5″,5″) is firmly connected to the first or the second cover plate (3,3′), in particular being bonded or soldered.

Numbered Paragraph 14. The thermal management module (1) according to any of Numbered Paragraphs 2 to 13, characterized in that the first and/or the second cover plate (3,3′) has an inward-facing or an outward-facing collar (12,13) at the at least one opening (11).

Numbered Paragraph 15. The thermal management module (1) according to any of Numbered Paragraphs 2 to 14, characterized in that the first and/or second cover plate (3,3′) has at least one alignment element (14).

Numbered Paragraph 16. The thermal management module (1) according to Numbered Paragraph 15, characterized in that the inward-facing or outward-facing collar (12,13) positions the first or at least second channel plate (4,4′) or the at least one connection flange (5,5′,5″,5″).

Numbered Paragraph 17. A method for manufacturing a thermal management module (1), in particular for an electrically powered motor vehicle,
wherein a first cover plate (3) with at least one first and one second channel plate (4,4′) and a second cover plate (3′) are arranged stacked on top of each other,
wherein at least one first and one second connection flange (5,5′,5″,5″) are arranged on the first cover plate (3),
wherein the module carrier (2) formed therewith is soldered or bonded,
wherein a valve device (7) and a sensor (9) are arranged on the at least one first and second connection flange (5,5′,5″,5″),
wherein at least one heat exchanger (8,8′) is arranged on the second cover plate (3′).

### LIST OF REFERENCES

1 thermal management module
2 module carrier
3,3′ cover plate
4,4′ channel plate
5,6′,5″,5″ connection flanges
6 collector
7 valve device
8,8′ heat exchangers
9 sensor
10,10′ channel
11 opening
12 inward-facing collar
13 outward-facing collar
14,14′ alignment element
15 sealing surface
16 first heat exchanging fluid guide
17 second heat exchanging fluid guide
18 turbulence structure
19 outer surfaces

1. A thermal management module, in particular for an electrically powered motor vehicle, having at least one module carrier, with at least one connection flange,
wherein
the at least one module carrier is formed from a first cover plate and a second cover plate, which seal the at least one module carrier upward and downward,
further comprising at least one channel plate is arranged between the first cover plate and the second cover plate, wherein the at least one channel plate facilitates at least one inner fluid guide.

2. The thermal management module according to claim 1, wherein the at least one channel plate has channels and the first cover plate and the second cover plate each have at least one opening.

3. The thermal management module according to claim 2, wherein the at least one channel plate and/or first cover plate and/or second cover plate comprise consist of a substantially flat sheet metal and is punched.

4. The thermal management module according to claim 2, wherein the at least one channel plate and first cover plate and second cover plate are fully stacked and the circumferential outer edges of the plates form outer surfaces of the at least one module carrier.

5. The thermal management module according to claim 3, wherein the at least one channel plate and/or first cover plate and/or second cover plate has a sheet thickness of 1 mm to 7 mm, especially preferably from 2 mm to 4 mm.

6. The thermal management module according to claim 3, wherein the second cover plate is a plastic component.

7. The thermal management module according to claim 2, wherein at least one second channel plate is arranged between the first cover plate and the second cover plate.

8. The thermal management module according to claim 7, wherein the first cover plate, the first channel plate and the at least one second channel plate and the second cover plate are fluid-tightly connected to one another, in particular being soldered or bonded.

9. The thermal management module according to claim 7 wherein the first channel plate and the at least one second channel plate have identically formed channels or differently formed channels.

10. The thermal management module according to claim 9, wherein the channels formed in the first channel plate and the at least second channel plate form at least one first heat exchanging fluid guide and one second heat exchanging fluid guide, facilitating a heat exchange with each other.

11. The thermal management module according to claim 10, wherein a channel is formed in the at least first channel plate, which does not form a fluid guide and has a thermal insulating effect.

12. The thermal management module according to claim 10, wherein turbulence generating structures are arranged in at least one of the first and second fluid guides exchanging heat with each other.

13. The thermal management module according to claim 1, wherein the at least one connection flange is firmly connected to the first or the second cover plate, in particular being bonded or soldered.

14. The thermal management module according to claim 2, wherein the first cover plate and/or the second cover plate has an inward at the at least one opening.

15. The thermal management module according to claim 14, wherein the first cover plate and/or second cover plate has at least one alignment element.

16. The thermal management module according to claim 15, wherein the inward-facing or outward-facing collar positions the first or at least second channel plate or the at least one connection flange.

17. A method for manufacturing a thermal management module, in particular for an electrically powered motor vehicle,
wherein a first cover plate with at least one first channel plate and one second channel plate and a second cover plate are arranged stacked on top of each other,
wherein at least one first connection flange and one second connection flange are arranged on the first cover plate,
wherein the module carrier formed therewith is soldered or bonded,
wherein a valve device and a sensor are arranged on the at least one first and second connection flange,
wherein at least one heat exchanger is arranged on the second cover plate.
